(19) United States
(12) Patent Application Publication
(10) Pub. No.: US 2008/0306766 A1
(43) Pub. Date: Dec. 11, 2008

(54) EXAMINATION-DATA PROCESSING APPARATUS AND EXAMINATION SYSTEM

(75) Inventors: Takeshi Ozeki, Kita-ku (JP); Takashi Masuzawa, Otawara-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 12/134,666

(22) Filed: Jun. 6, 2008

(30) Foreign Application Priority Data
Jun. 7, 2007 (JP) 2007-151247

(51) Int. Cl. G06Q 50/00

(52) U.S. Cl. 705/2

(57) ABSTRACT

An examination system comprises an examination apparatus 1 and a workstation 10. The examination apparatus 1 executes an examination on a patient to acquire a plurality of examination data and acquire an examination time of each of the examination data. The workstation 10 creates a procedure log that associates a procedure item executed on the patient with a procedure time thereof. The workstation 10 displays a chronological display screen 100 on a display 13 based on the procedure log and an examination time. An operator operates an operation part 14 to designate a procedure item in the chronological display screen 100. The workstation 10 extracts partial data within a range that corresponds to the designated procedure item from each of the examination data based on the examination time and the procedure log, and synchronizes and displays the extracted partial data on the display 13.

### BACKGROUND OF THE INVENTION

1. Field of the Invention

The present invention relates to an examination-data processing apparatus configured to process data acquired from an examination in the medical field and an examination system configured to execute an examination in the medical field. To be specific, the present invention relates to a technique used in the case of executing a plurality of examinations in parallel.

2. Description of the Related Art

In the medical field, there is a case of executing a plurality of examinations in parallel. For example, in a cardiovascular examination, there is a case of executing an X-ray contrast examination, an IVUS (interventional ultrasonic) examination, a polygraph examination (a hemodynamic examination), an electrocardiogram (ECG) examination, etc. in parallel. Further, during an operation, there is a case of executing capture of an image, electrocardiogram examination, blood-pressure examination, etc. of a patient in parallel.

In conventional techniques, data (examination data) acquired from a plurality of examinations are processed individually (refer to International Publication 2003/001421). Further, a plurality of examination data are independently displayed while not mutually linked. Further, it is possible to display a plurality of examination data side by side, but it is only possible to display each examination data independently. As an exception, in the case of executing an ECG gated examination, it is possible to display captured images in association with time phases of a heart.

Thus, in the conventional techniques, except the ECG gated examination etc., in the case of executing a plurality of examinations in parallel, it is only possible to synchronize and display examination data of the plurality of examinations, and it is only possible to individually observe a plurality of examination data. Therefore, it is not possible to easily grasp the relationship between different examination data.

Further, in the conventional techniques, observation of a plurality of examination data acquired simultaneously requires temporal regulation of the respective examination data, and needs a complicated operation and much time. For example, the aforementioned cardiovascular examination requires matching of the capture time of an X-ray contrast examination, the capture time of an IVUS examination, the examination time of a polygraph examination, and the examination time of an electrocardiogram examination with a desired time.

Furthermore, in the conventional techniques, in the case of executing a sequential examination such as capture of moving images and a polygraph examination, it is only possible to display the result of the examination chronologically, and therefore, it is difficult to selectively display examination data of a desired timing. For example, in a cardiovascular examination, there is a case of closely observing examination data of a timing for executing a desired event such as diastolic treatment of a angiostenosis part using medication, a balloon catheter or a stent, but in the conventional techniques, it takes a lot of time and effort for displaying various types of examination data of a desired timing.

### SUMMARY OF THE INVENTION

The present invention has been made to solve the above problems, and an object of the invention is to provide an examination-data processing apparatus and an examination system that are capable of synchronously replay examination data acquired from a plurality of examinations with ease.

In a first aspect of the present invention, an examination-data processing apparatus comprises: a storage configured to store by associating each of a plurality of examination data of a patient acquired by an examination apparatus with an examination time indicating time when the examination data has been acquired, and store by associating procedure items executed on the patient in relation to the examination by the examination apparatus with procedure times thereof; a display; and a controller configured to extract partial data in a time range corresponding to a specific procedure item from each of the plurality of examination data based on the examination time and the procedure times, and control the display to synchronously display the plurality of extracted partial data.

According to the first aspect, it is possible to extract partial data in a time range corresponding to a specific procedure item from each of the examination data based on the examination time and the procedure time, and cause the display to synchronously display the extracted partial data. Therefore, an operator does not need to synchronize the examination data. Consequently, it becomes possible to synchronously replay a plurality of examination data with ease.

In a second aspect of the present invention, an examination system comprises: an examination apparatus configured to acquire a plurality of examination data from examinations on a patient, and acquire an examination time indicating time when each of the plurality of examination data is acquired; a storage configured to store by associating procedure items executed on the patient in relation to an examination by the examination apparatus with procedure times thereof; a display; and a controller configured to extract partial data in a time range corresponding to a specific procedure item from each of the plurality of examination data based on the examination time and the procedure time, and control the display to synchronously display a plurality of the extracted partial data.

According to the second aspect, it is possible to extract partial data in a time range corresponding to a specific procedure item from each of the examination data based on the examination time and the procedure time, and cause the display to synchronously display the extracted partial data. Therefore, the operator does not need to synchronize the examination data to display on the display. Consequently, it becomes possible to synchronously replay a plurality of examination data with ease.

### BRIEF DESCRIPTION OF THE DRAWINGS

FIG. 1 is a schematic diagram showing an example of the entire configuration in an embodiment of an examination system according to the present invention.

FIG. 2 is a schematic block diagram showing an example of the configuration in the embodiment of the examination system according to the present invention.

FIG. 3 is a flowchart showing an example of the usage pattern in the embodiment of the examination system according to the present invention.

FIG. 4 is a flowchart showing an example of the usage pattern in the embodiment of the examination system according to the present invention.

FIG. 5 is a schematic view showing an example of a display screen in the embodiment of the examination system according to the present invention.

FIG. 6 is a schematic view showing an example of a display screen in the embodiment of the examination system according to the present invention

FIG. 7 is a schematic view showing an example of a display screen in the embodiment of the examination system according to the present invention.

FIG. 8 is a schematic diagram showing an example of the entire configuration of a modification of the examination system according to the present invention.

FIG. 9 is a schematic block diagram showing an example of the configuration of the modification of the examination system according to the present invention.

FIG. 10 is a flowchart showing an example of the usage pattern in the modification of the examination system according to the present invention.

FIG. 11 is a flowchart showing an example of the usage pattern in the modification of the examination system according to the present invention.

### DETAILED DESCRIPTION OF THE PREFERRED EMBODIMENTS

An embodiment of an examination-data processing apparatus and an examination system according to the present invention will be described in detail referring to the drawings.

### [Configuration]

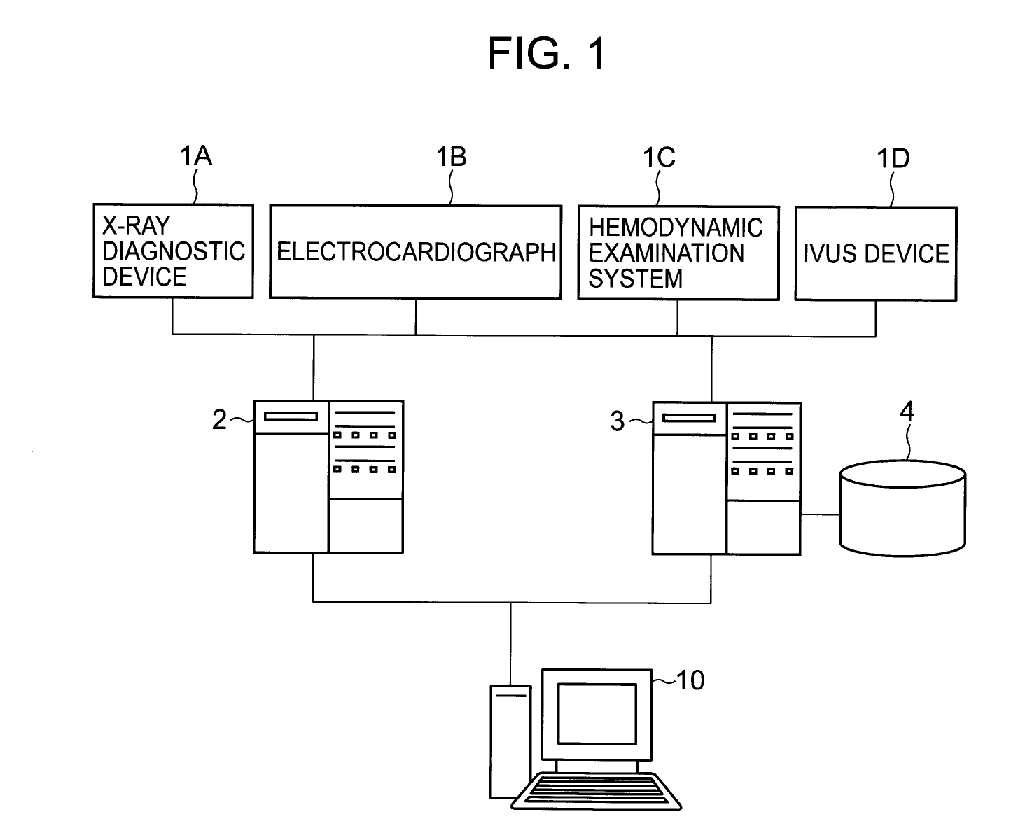

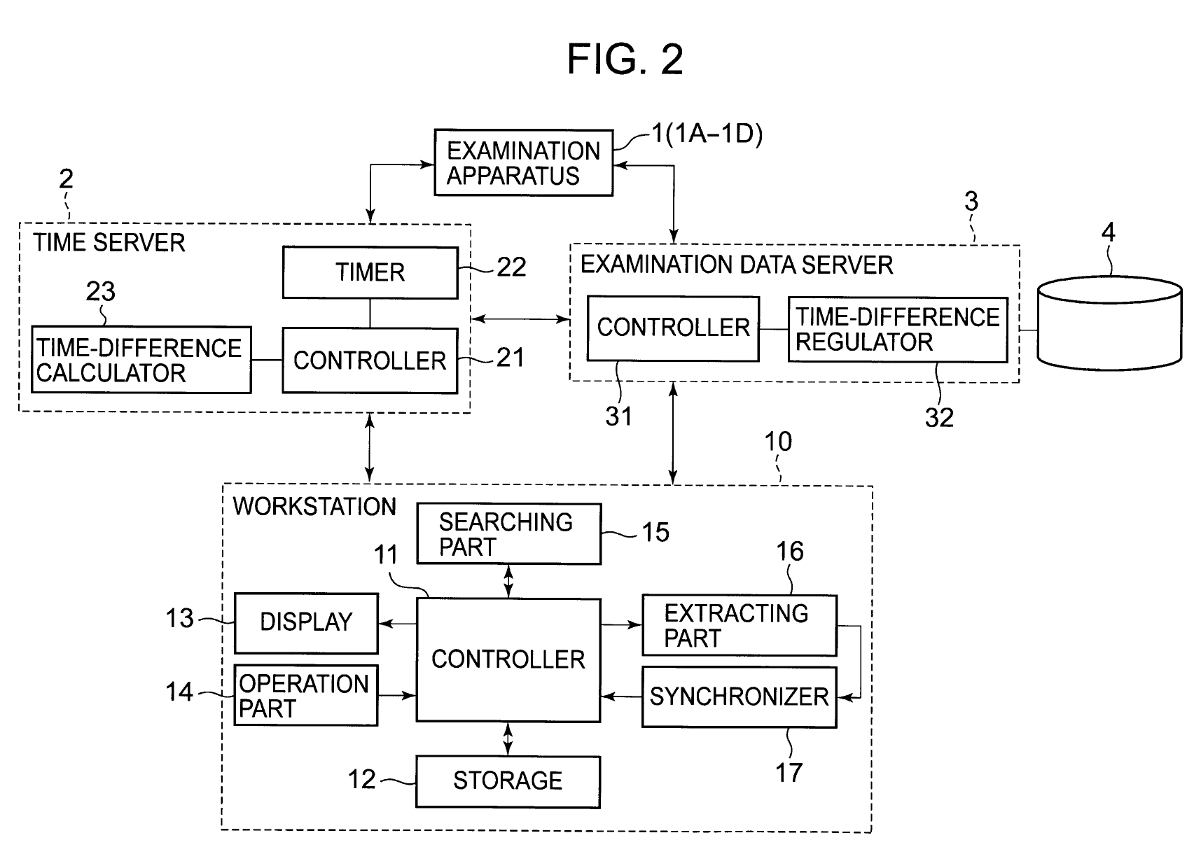

First, the configuration of the examination system in the embodiment will be described referring to FIGS. 1 and 2.

For example, this examination system is configured in compliance with the DICOM (Digital Imaging and Communications in Medicine), which is a standard regarding digital medical images.

This examination system comprises an examination apparatus 1, a time server 2, an examination data server 3, an examination database 4, and a workstation 10. These apparatuses are connected by a communication network such as a LAN (Local Area Network) and a dedicated line.

The examination-data processing apparatus according to the present invention may be configured by excluding at least the examination apparatus I from this examination system. For example, the examination-data processing apparatus according to the present invention may be configured by: (1) the workstation 10 alone; (2) the workstation 10 and the time server 2; (3) the workstation 10, the examination data server 3, and the examination database 4; or (4) the workstation 10, the time server 2, the examination data server 3, and the examination database 4.

### [Examination Device]

As shown in FIG. 1, this examination system has a plurality of examination devices 1A-1D used for a cardiovascular examination. The respective examination devices 1A-1D are used independently. Therefore, it is possible to execute two or more examinations on a patient in parallel. In FIG. 2, these examination devices 1A-1D are collectively referred to as the “examination apparatus 1.”

### (X-Ray Diagnostic Device)

The examination device 1A is an X-ray diagnostic device. The X-ray diagnostic device 1A is a device configured to capture an X-ray fluoroscopic image of the inside of a patient's body. As conventional, the X-ray diagnostic device 1A is capable of capturing a still image, and is also capable of capturing a moving image. The X-ray diagnostic device 1A is also used for measuring the size or the like of an attention site within a captured image. Herein, the “size” refers to a physical quantity to which the morphology of an attention site is reflected, such as the length, area, volume, peripheral length, weight, etc.

The X-ray diagnostic device 1A includes a part configured to measure a current time. This part is composed of, for example, a general microprocessor having a timer function. The X-ray diagnostic device IA provides image data (digital data) of a captured image with a capture time thereof. The capture time is recorded as, for example, incidental information in the DICOM standard. In this specification, the “image data” may be regarded as identical to an “image.”

In the case of capturing a moving image, it is possible to provide each of still images composing the moving image with the capture time. For example, in a case where the frame rate of a moving image is 30 f/s, each frame (still image) acquired every 1/30 sec is provided with the capture time.

Instead of providing each of the still images composing a moving image with the capture time, it is possible to provide one of the still images with the capture time and record the frame rate. For example, in the case of providing a first still image with the capture time, it is possible to calculate the capture time of an N^{th} still image by adding the product of the inverse of the frame rate (i.e., frame interval) and N-1 to the capture time. In the present embodiment, it is possible to apply any information that makes it possible to obtain the capture time of each of the still images composing a moving image. Such information is equivalent to an example of the “examination time” according to the present invention.

The X-ray diagnostic device 1A provides an acquired image with identification information (image ID). This image ID is recorded into the incidental information of the DICOM. In the case of a moving image, it is possible to provide each of the still images with the image ID.

The X-ray diagnostic device IA transmits captured images (examination data) to the examination data server 3, together with the image ID and capture time (incidental information). The examination data may be, for example, the result of measurement of an attention site. Moreover, the X-ray diagnostic device 1A transmits the image ID and capture time (incidental information) to the time server 2. At this moment, the X-ray diagnostic device 1A also transmits the transmission time of the data to the time server 2. Also this transmission time can be recorded into the incidental information of the DICOM.

### (Electrocardiograph)

The examination device 1B is an electrocardiograph. The electrocardiograph 1B is a device configured to acquire a graph (electrocardiogram) in which a temporal change in electrical phenomenon of a heart is recorded.

The electrocardiograph 1B includes a part configured to measure a current time. The electrocardiograph 1B detects an electrical phenomenon of a heart at predetermined time intervals, and generates digital data (examination data) in which the result of the detection and the time of the detection are associated. This examination data composes graph data of an electrocardiogram that shows a temporal change in detected value.

It is possible to give the detection time at every detection timing, or it is possible to give the detection time at one detection timing and a detection time interval. The information indicating the detection time is equivalent to an example of the “examination time” according to the present invention.

The electrocardiograph 1B provides the examination data with identification information (examination ID). The examination ID may be given to each examination data, or may be given at each detection time.

The electrocardiograph 1B transmits the examination data, the examination ID and the detection time to the examination data server 3. The electrocardiograph 1B also transmits the examination ID and the detection time to the time server 2. At this moment, the electrocardiograph 1B also transmits the transmission time of the data to the time server 2.

### (Hemodynamic Examination System)

The examination device 1C is a hemodynamic examination system. The hemodynamic examination system 1C is used for a polygraph examination (hemodynamic examination). The polygraph examination is examination of hemodynamics by measuring a temporal change in pressure at various positions within a cardiac cavity.

The hemodynamic examination system 1C includes a part configured to measure a current time. The hemodynamic examination system 1C measures pressure at each measurement position at predetermined time intervals and generates digital data (examination data) in which the result of the measurement and the time of the measurement are associated. This examination data composes graph data indicating a temporal change in pressure at each measurement position.

It is possible to give the measurement time at every measurement timing, or it is possible to give the measurement time at one measurement timing and a measurement time interval. The information indicating the measurement time is equivalent to an example of the “examination time” according to the present invention.

The hemodynamic examination system 1C provides the examination data with identification information (examination ID). The examination ID may be given to each examination data, or may be given at each measurement time.

The hemodynamic examination system 1C transmits the examination data, the examination ID and the measurement time to the examination data server 3. Further, the hemodynamic examination system 1C transmits the examination ID and the measurement time to the time server 2. At this moment, the hemodynamic examination system 1C also transmits the transmission time of the data to the time server 2.

### (IVUS Device)

The examination device 1D is an IVUS device. The IVUS device 1D is a device for executing an interventional ultrasonic examination. The IVUS device 1D is a device that has an ultrasonic probe disposed to the tip of a catheter and captures a tomographic image of a blood vessel with the ultrasonic probe inserted into the blood vessel. The IVUS device 1D is capable of capturing a still image, and is also capable of capturing a moving image. Further, the IVUS device 1D is used for measuring the size of an attention site within a captured image.

The IVUS device 1D includes a part configured to measure a current time. The IVUS device 1D provides image data (digital data) of a captured image with the capture time. In the case of a moving image, it is possible to provide each of the still images composing the moving image with the capture time, or it is possible to give the capture time of one of the still images and a frame rate. Such information is equivalent to an example of the “examination time” according to the present invention.

The IVUS device 1D provides the acquired image with identification information (image ID). In the case of a moving image, it is possible to provide each still image with the image ID. For example, the image ID and the capture time are recorded into the incidental information of the DICOM.

The IVUS device 1D transmits a captured image (examination data) to the examination server 3, together with the image ID and capture time (incidental information). The examination data may be the result of measurement of an attention site, or the like. Further, the IVUS device 1D transmits the image ID and capture time (incidental information) to the time server 2. At this moment, the IVUS device 1D also transmits the transmission time of the data to the time server 2. The transmission time can be also recorded into the incidental information of the DICOM.

The current times measured by the respective examination devices 1A-1D do not need to synchronized with each other. That is, the examination times generated by the respective examination devices 1A-1D are not synchronized. Therefore, even if examinations are executed at the same time, the examination times given by the respective examination devices 1A-1D do not need to coincide.

Further, with the examination data acquired by the examination devices 1A-1D in one cardiovascular examination, identification information of the cardiovascular examination (cardiovascular examination ID) and identification information of a patient (patient ID) are associated. Consequently, it is possible to integrally manage various types of examination data acquired in one cardiovascular examination. Such ID for integral management is transmitted to the time server 2 and the examination data server 3, together with the abovementioned data.

### [Time Server]

A time server 2 is a computer configured to manage information on time referred to in the examination system. Specifically, the time server 2 executes a process for synchronizing examination times sent from the respective examination devices 1A-1D. The time server 2 includes a controller 21, a timer 22, and a time-difference calculator 23.

### (Controller)

The controller 21 controls each part of the time server 2. The controller 21 includes a microprocessor such as a CPU, a RAM, a ROM, and a hard disk drive. Further, the controller 21 is provided with a communication device such as a LAN card.

The controller 21 receives data sent from the respective examination devices 1A-1D, and inputs the data into the time-difference calculator 23. Moreover, the controller 21 acquires a time at which the timer 22 times, and sends it to the time-difference calculator 23 and the other apparatuses.

### (Timer)

The timer 22 times a time to become a reference in this examination system. This time shall be referred to as a reference time. The timer 22 is formed by, for example, a general microprocessor having a timer function.

The timer 22 may have a function of automatically correcting time by acquiring an accurate time from outside. The accurate time is provided by, for example, a time server on the Internet, or a radio master clock that transmits a standard time radio wave.

The time server 2 having the timer 22 functions as the “first server” of the present invention.

### (Time-Difference Calculator)

As mentioned above, the time server 2 executes a process for synchronizing the examination times sent from the respective examination devices 1A-1D. The time-difference calculator 23 executes this process. This process will be described below.

For a moving image acquired by the X-ray diagnostic device 1A, the image ID of a plurality of still images composing the moving image is denoted as “Gk,” and the capture time of each of the still images is denoted as “tA(k)” (k=1, 2, . . . , K: acquisition order). Moreover, the transmission time from the X-ray diagnostic device 1A is denoted as tA.

For the examination data acquired by the electrocardiograph 1B, the examination ID of a plurality of detection values composing the examination data is denoted as “E1,” and the detection time of the respective detection values is denoted as “tB(l)” (l=1, 2, . . . , L: acquisition order). Moreover, the transmission time from the electrocardiograph 1B is denoted as tB.

For the examination data acquired by the hemodynamic examination system 1C, the examination ID of a plurality of measurement values composing the examination data is denoted as “Pm,” and the measurement time of each of the measurement values is denoted as “tC(m)” (m=1, 2, . . . , M: acquisition order). Moreover, the transmission time from the hemodynamic examination system 1C is denoted as tC.

For a moving image acquired by the IVUS device 1D, the image ID of a plurality of still images composing the moving image is denoted as “Un,” and the capture time of each of the still images is denoted as “tD(n)” (n=1, 2, . . . , N: acquisition order). Moreover, the transmission time from the IVUS device 1D is denoted as tD.

When receiving data from the X-ray diagnostic device 1A, the controller 21 acquires the reception time TA from the timer 22. At this moment, assuming the transfer rate of the data is sufficiently fast, it is possible to consider that the time server 2 receives the data simultaneously when the X-ray diagnostic device 1A transmits the data. Thus, when a reference time at which the time server 2 times coincides with a time at which the X-ray diagnostic device 1A times, it is possible to regard the transmission time tA as equal to the reception time TA.

However, the timing times do not coincide among the apparatuses. In such a case, the transmission time tA and the reception time TA generally differ from each other. At this moment, considering the abovementioned assumption, a time difference ΔtA=tA−TA between the transmission time tA and the reception time TA is equivalent to a time difference in timing time of the X-ray diagnostic device 1A with respect to the reference time.

In consideration of the above background, the time-difference calculator 23 calculates the time difference ΔtA in timing time of the X-ray diagnostic device 1A with respect to the reference time. Similarly, the time-difference calculator 23 calculates the time difference ΔtB in timing time of the electrocardiograph 1B, the time difference ΔtC in timing time of the hemodynamic examination system 1C and the time difference ΔtD in timing time of the IVUS device 1D with respect to the reference time.

The controller 21 transmits the calculated time differences ΔtA, ΔtB, ΔtC and ΔtD to the examination data server 3. At this moment, the image ID and the examination ID are transmitted in association with each of the time differences. Consequently, it is possible to specify which time difference corresponds to which examination data.

In the above description, the transmission time from the examination apparatus 1 to the time server 2 is assumed to be zero. However, in a case where the transmission time cannot be ignored, the time difference can be calculated in consideration of, for example, an actual measurement value or theoretical value of the transmission time.

Moreover, in such a case that the time difference in timing time of the examination apparatus 1 with respect to the reference time does not change significantly in a short time period, there is no need to transmit the image ID and the examination ID to the time server 2. On the other hand, in the case of emphasizing the accuracy of calculation of the time difference, it is desirable to transmit the image ID and the examination ID to calculate the time difference at the time of the image capture or the examination.

The time-difference calculator 23 includes a microprocessor, a RAM, a ROM, a hard disk drive, etc. The time-difference calculator 23 functions as an example of the “time-difference calculator” according to the present invention.

### [Examination Data Server and Examination Database]

The examination data server 3 is a computer configured to manage the examination data acquired by the respective devices of the examination apparatus 1. The examination data server 3 functions as an example of the “second server” according to the present invention. The examination database 4 is disposed adjacent to the examination data server 3.

The examination database 4 includes a storage device configured to store the examination data in a searchable manner. This storage device is a high-capacity storage device such as a hard disk drive.

The examination data server 3 and the examination database 4 function as an image archiving system such as a PACS (Picture Archiving and Communication System). The image archiving system stores images captured by the X-ray diagnostic device 1A and the IVUS device 1D.

Moreover, the examination data server 3 and the examination database 4 also function as a system configured to store various examination results including graph data such as electrocardiogram and polygraph.

The examination data server 3 manages the examination data stored in the examination database 4. Information such as various examination data acquired in a cardiovascular examination is integrally managed based on the abovementioned cardiovascular examination ID, patient ID, etc. The examination data server 3 includes a controller 31 and a time-difference regulator 32.

### (Controller)

The controller 31 controls each part of the examination data server 3. The controller 31 includes a microprocessor, a RAM, a ROM, a hard disk drive, etc. Further, the controller 31 includes a communication device such as a LAN card.

The controller 31 receives data transmitted from the respective examination devices 1A-1D and stores the data into the examination database 4. Moreover, in response to, for example, a request from the workstation 10, the controller 31 retrieves the data stored in the examination database 4 and transmits the data to the source of the request.

Moreover, the controller 31 receives the time differences ΔtA, ΔtB, ΔtC and ΔtD transmitted from the time server 2 and stores them in the examination database 4. It is also possible to configure to store the time differences into the hard disk drive thereof.

### (Time-Difference Regulator)

The time-difference regulator 32 regulates the times of the examination data. To be more specific, the time-difference regulator 32 executes a process of converting the examination time of the respective examination data into a reference time. Moreover, by executing this process on the respective examination data, the examination times are synchronized among the different types of examination data. A detailed example of this process will be described below.

First, the controller 31 inputs the time differences ΔtA, ΔtB, ΔtC and ΔtD from the time server 2, the examination data from the respective examination devices 1A-1D, etc., into the time-difference regulator 32.

For each of the still images (image ID “Gk”) captured by the X-ray diagnostic device 1A, the time-difference regulator 32 converts the capture time tA(k) into a reference time based on the time difference ΔtA (tA(k)′=tA(k)−ΔtA). Here, tA(k)′ is equivalent to the reference time when the k^{th} image was taken.

Similarly, for each of the detection values (examination ID “E1”) of the examination data acquired by the electrocardiograph 1B, the time-difference regulator 32 converts the detection time tB(1) into a reference time based on the time difference ΔtB (tB(1)′=tB(1)−ΔtB). Moreover, for each of the measurement values (examination ID “Pm”) of the examination data acquired by the hemodynamic examination system 1C, the time-difference regulator 32 converts the measurement time tC(m) into a reference time based on the time difference ΔtC (tC(m)′=tC(m)−ΔtC). Moreover, for each of the still images (image ID “Un”) acquired by the IVUS device 1D, the time-difference regulator 32 converts the capture time tD(n) into a reference time based on the time difference ΔtD(tD(n)′=tD(n)−ΔtD).

Consequently, the examination time of each of the examination data is set to the reference time, and the different data are synchronized with each other via the reference time. The results calculated by the time-difference regulator 32 are associated with the corresponding examination data and stored in the examination database 4. These calculated results are recorded, for example, as incidental information of the corresponding examination data.

The time-difference regulator 32 that operates as described above comprises a microprocessor, a RAM, a ROM, a hard disk drive, etc. The time-difference regulator 32 functions as an example of the “converter” according to the present invention.

### [Workstation]

The workstation 10 functions as an example of the “computer” according to the present invention. The workstation 10 is used for observing examination data acquired by the examination device 1. Moreover, the workstation 10 is used to input a procedure log.

The procedure log is information in which a procedure item (event) applied to a patient in execution of a cardiovascular examination and a procedure time are recorded. Examples of the event include injection of a drug such as contrast medium and cardiotonic, expansion of vessels by using a stent and a balloon catheter, etc.

The procedure log is inputted into the workstation 10 during execution of a cardiovascular examination or after execution of a cardiovascular examination. In the case of the former case, the workstation 10 is situated in an examination room. Moreover, in such a case that the examination room is videotaped, the workstation 10 can be placed in any location where the video image can be observed. On the other hand, in the case of the latter case, the workstation 10 can be situated at any place. In the case of the latter case, a record is created by handwriting or the like during the examination, and the information is inputted with reference to this record.

The workstation 10 includes a controller 11, a storage 12, a display 13, an operation part 14, a searching part 15, an extracting part 16, and a synchronizer 17.

### (Controller)

The controller 11 controls each part of the workstation 10. The controller 11 includes a microprocessor, a RAM, a ROM, a hard disk drive, etc. Further, the controller 11 is provided with a communication device such as a LAN card.

The controller 11 executes various kinds of processes regarding a procedure log. An example of an operation in the case of inputting a procedure log during an examination will be described. Another example of the operation will be described later.

As shown in FIG. 1 and FIG. 2, the workstation 10 is connected to the time server 2. When an event is inputted, the controller 11 acquires a reference time in the input timing, and creates a procedure log in association with the inputted event. The created procedure log is stored in the storage 12.

There are two patterns of acquisition of the reference time, for example. As a first pattern, it is possible to configure to constantly receive the reference time from the time server 2 and use the reference time received at timing that an event is inputted. As a second pattern, it is possible to configure so that a signal is transmitted to the time server 2 when an event is inputted and the time server 2 having received this signal provides the reference time.

### (Storage)

The storage 12 stores various data such as examination data and procedure logs. The storage 12 includes a storage device such as a hard disk drive. The process of storing data in the storage 12 and the process of retrieving data stored in the storage 12 are executed by the controller 11.

### (Display)

The display 13 is controlled by the controller 11 so as to display various data such as examination data. The display 13 is composed of any display device such as an LCD (Liquid Crystal Display) and a CRT (Cathode Ray Tube) display.

### (Operation Part)

The operation part 14 is operated by an operator to make the workstation 10 execute various processes. The operation part 14 is composed of any operating device or input device such as a keyboard, a mouse, a trackball and a joystick.

The operation part 14 operated by the operator inputs a manipulated signal corresponding to the content of an operation into the controller 11. The controller 11 controls each part of the workstation 10 based on this operation signal so as to execute the operation requested by the operator.

To be specific, the operation part 14 is operated for designating a cardiovascular examination ID, a patient ID, an event recorded in a procedure log, and the like.

### (Searching Part)

The searching part 15 searches examination data managed by the examination data server 3. The searching part 15 includes a microprocessor, a communication device, and so on.

In particular, when the operator designates a cardiovascular examination ID and/or a patient ID, the searching part 15 acquires examination data and incidental information relevant to the content of the designation from the examination data server 3. This process will be described in further detail.

When the operator designates an ID, the searching part 15 transmits the designated ID to the examination data server 3, together with the network address of the workstation 10.

The examination data server 3 searches out examination data and incidental information associated with this ID from the examination database 4. Then, the examination data server 3 transmits the result of the search to the workstation 10 based on the received network address.

The searching part 15 receives this search result and inputs it into the controller 11. The controller 11 stores this search result in the storage 12.

### (Extracting Part)

When an event recorded in a procedure log is designated by the operator, the extracting part 16 extracts a part corresponding to this event from each of the examination data. This process will be described in more detail.

The storage 12 stores the examination data and incidental information and the procedure logs. The examination data and incidental information have been searched by the searching part 15. The procedure log has been created by the controller 11. Here, the examination time recorded in the incidental information has been converted into the reference time. The procedure time recorded in the procedure log has also been converted to the reference time. Moreover, the procedure log associates the event with the procedure time.

In each event recorded in the procedure log, a period for observing (an observation period) is set in advance. The observation period may be set by default or by the operator.

The observation period is set in accordance with the type of an event, the execution time thereof, etc. The observation period contains at least one of the periods before or after the procedure time in accordance with the type of an event, etc. That is, the observation period includes an observation period set to only before the procedure time, an observation period set to after the procedure time, and an observation period set to before and after the procedure time.

Now, when the operator designates an event, the extracting part 16 first specifies an observation period corresponding to this event. Moreover, the extracting part 16 refers to the procedure log to specify the procedure time associated with this event.

Next, the extracting part 16 extracts a part for observation (partial data) from each of the examination data based on the specified observation period and procedure time. A specific example of this process will be described. It is assumed that the specified observation period is “1 minute after the procedure time” and the procedure time is “10:05:35.” At this moment, the period for observation is 1 minute from 10:05:35, namely, 10:05:35-10:06:35.

In the incidental information of each of the examination data, the examination time is recorded. For example, K sheets of still images (image ID “Gk”; k=1−K) composing a moving image captured by the X-ray diagnostic device 1A are provided with capture times tA(k), respectively. The extracting part 16 specifies still images (partial data) so that its capture time tA(k) is included in the period for observation “10:05:35-10:06:35.” The image IDs of the specified still images are denoted as “G(k1)”−“G(k2).”

Furthermore, the extracting part 16 extracts the specified partial data for each of the examination data. In the abovementioned example, still images having the image IDs in the range of “G(k1)”−“G(k2)” are extracted. As for examination data in which the period for observation and the examination time do not overlap, partial data is not extracted.

### (Synchronizer)

The synchronizer 17 synchronizes partial data extracted from each of the examination data by the extracting part 16. This process is executed when partial data is extracted from a plurality of examination data. A specific example will be described below.

It is assumed that partial data is extracted from a moving image captured by the X-ray diagnostic device 1A and a polygraph acquired by the hemodynamic examination system 1C. It is assumed that from the moving image, still images in the range of image ID “G(k1)”−“G(k2)” are extracted. Moreover, it is assumed that from the polygraph, measurement values in the range of examination ID “P(m1)”−“P(m2)” are extracted.

The synchronizer 17 aligns the plurality of extracted still images and the plurality of extracted measurement values on the same time axis. For example, a still image with an image ID “G(k1)” and a measurement value with an examination ID “P(m1)” are associated with Time 0. Furthermore, the still images with an image ID “G(k1+1)” and thereafter are associated with times based on the respective capture times. The measurement value with an examination ID “P(m1+1)” and thereafter are associated in a similar way. Furthermore, the examination data may be aligned on the time axis based on a frame rate of the moving image and measurement intervals of the measurement value.

### [Usage Pattern]

An example of a usage pattern of the examination system according to this embodiment will be described. A usage pattern in acquisition of examination data, etc. and a usage pattern in observation of examination data will be described separately.

[Usage Pattern in Acquisition of Examination Data, etc]

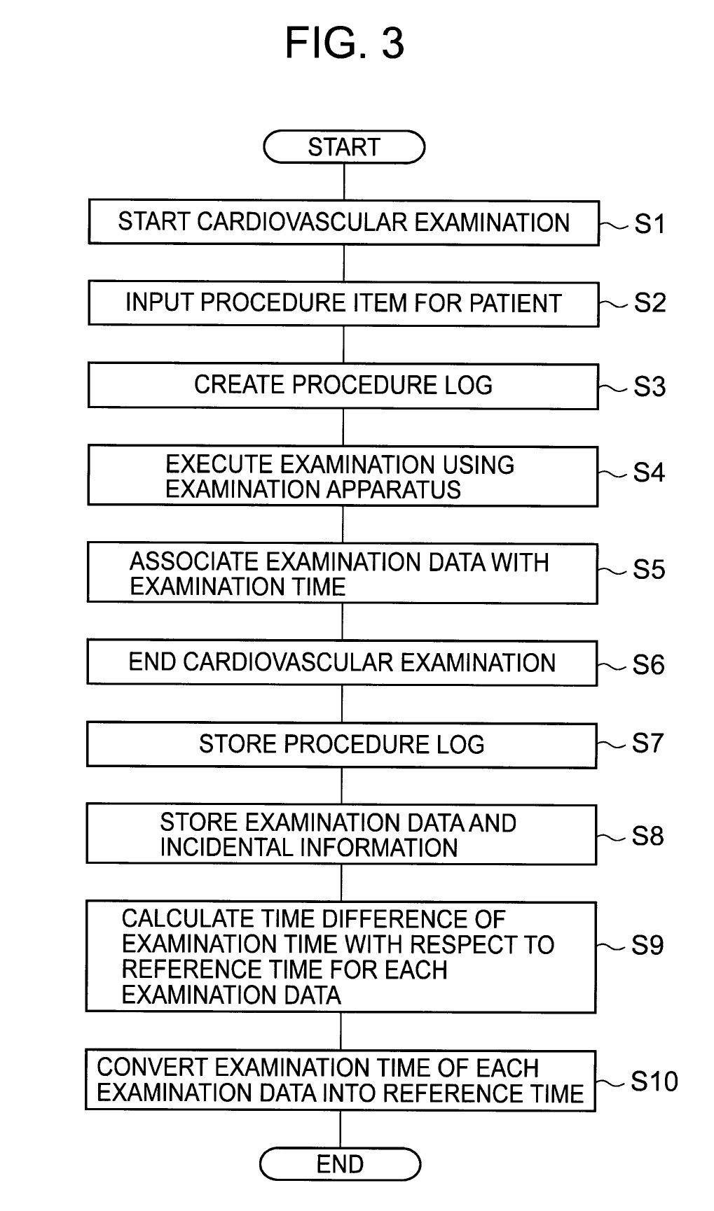

Firstly, an example of the usage pattern in acquisition of examination data, etc., will be described with reference to a flowchart shown in FIG. 3. Here, a case of inputting a procedure log into the workstation 10 during a cardiovascular examination will be described.

A cardiovascular examination is started (S1). An input screen for inputting a procedure log is displayed on the display 13 of the workstation 10.

When a procedure is applied to a patient, a person like a nurse operates the operation part 14 to input the procedure item (S2). The controller 11 associates the inputted procedure item with the reference time provided by the time server 2, and creates a procedure log (S3). The process of creating a procedure log is executed every time a procedure is applied to a patient.

Moreover, a person like a doctor or a radiological technician executes an examination using the examination apparatus I on the patient (S4). The examination apparatus 1 associates the acquired examination data with the examination time (S5). The examination time is recorded as, for example, incidental information of the examination data.

Creation of the procedure log and examination using the examination apparatus 1 are executed at arbitrary timing during the cardiovascular examination. Therefore, the creation and the examination may be in any order and at any number of times, and are not limited to the content shown in the flowchart of FIG. 3.

When the cardiovascular examination ends (S6), the controller 11 of the workstation 10 stores the created procedure log into the storage 12, together with the cardiovascular examination ID and the patient ID (S7).

Moreover, each of the devices of the examination apparatus 1 transmits the examination data and the incidental information to the examination data server 3. The examination data server 3 receives the examination data and the incidental information from each of the devices of the examination apparatus 1, and stores them into the examination database 4 (S8). In this incidental information, the examination time, the examination ID, the cardiovascular examination ID, the patient ID, etc., are recorded according to the type of examination.

Moreover, each of the devices of the examination apparatus 1 transmits information for calculating the time difference, namely, the examination ID, the examination time and the transmission time, to the time server 2. The time-difference calculator 23 calculates the time difference with respect to the reference time for each of the examination times (S9).

The controller 21 transmits the time difference of each of the examination times to the examination data server 3 together with the examination ID, etc. For each of the examination data stored in the examination database 4, the time-difference regulator 32 converts the examination time into a reference time (S10). The result of the conversion is, for example, recorded in the incidental information and stored in the examination database 4. This concludes the description of the usage pattern in acquisition of examination data, etc.

### [Usage Pattern in Observation of Examination Data]

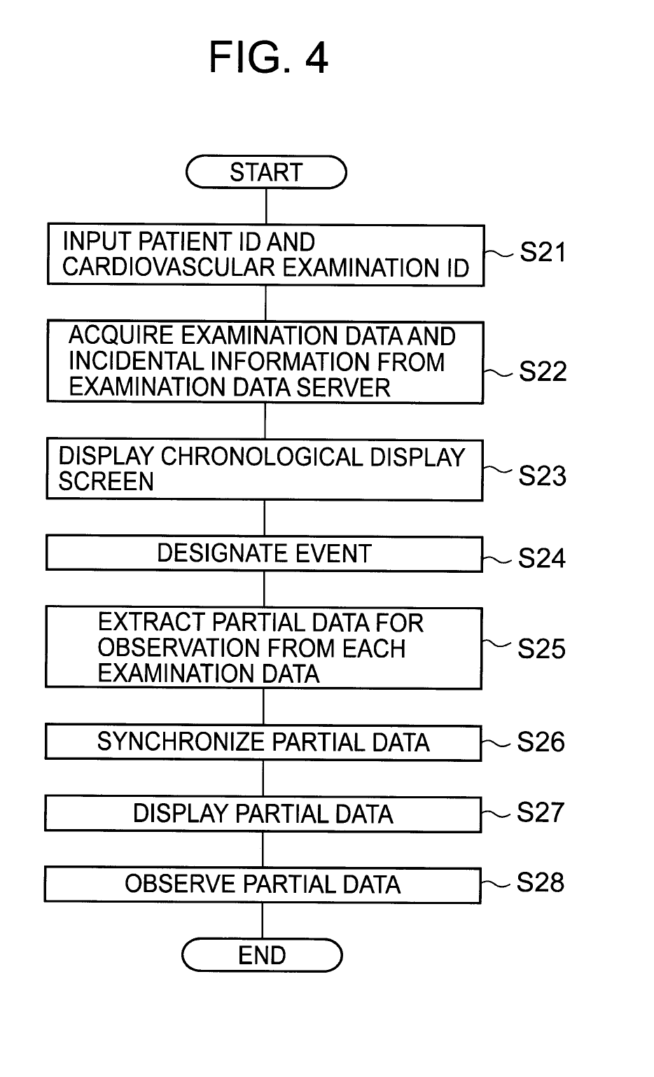

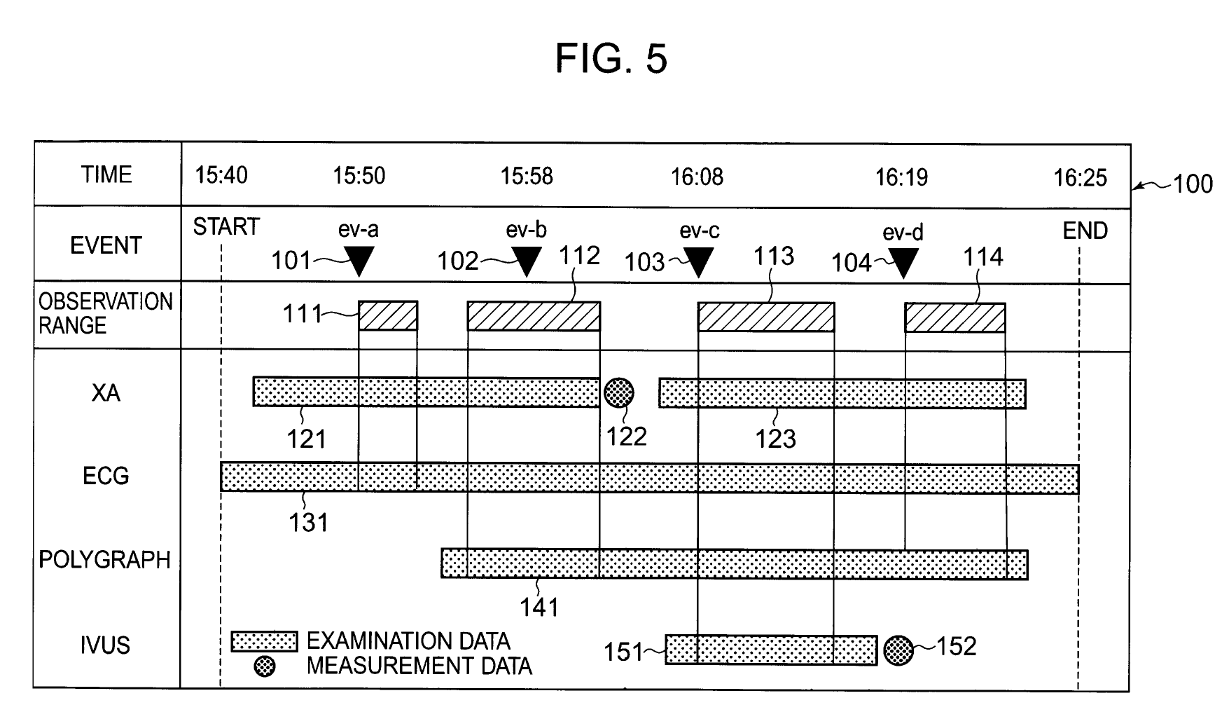

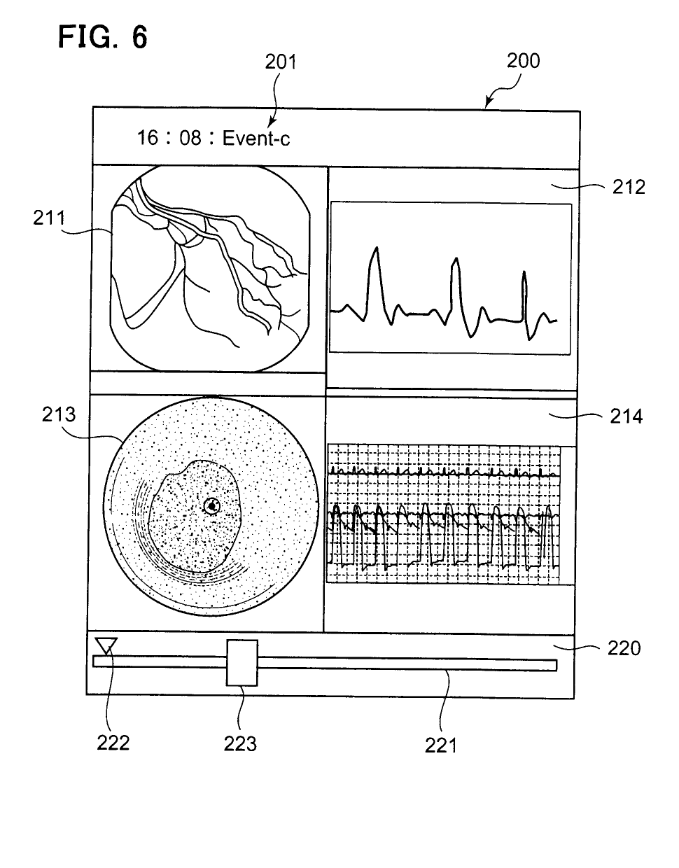

Next, an example of the usage pattern in observation of examination data will be described with reference to FIGS. 4, 5 and 6. FIG. 4 is a flowchart showing an example of the usage pattern. FIG. 5 and FIG. 6 show examples of a display screen for observing examination data.

Firstly, an operator of the workstation 10 operates the operation part 14 to input a patient ID and a cardiovascular examination ID (S21). The searching part 15 acquires examination data and incidental information relevant to the inputted ID from the examination data server 3 (S22). The controller 11 stores the acquired examination data and incidental information into the storage 12.

The controller 11 retrieves the procedure log and incidental information associated with the ID inputted in Step 21 from the storage 12. In addition, the controller 11 controls the display 13 so as to display a chronological display screen 100 shown in FIG. 5, based on the retrieved data (S23).

The chronological display screen 100 will be described. The chronological display screen 100 is a screen that lists events and examinations conducted in a cardiovascular examination in the chronological order. The configuration and creation method of the chronological display screen 100 will be described below.

The chronological display screen 100 has a time column, an event column, an observation range column, and an examination time column. In the examination time column, information showing the type of each examination conducted during the cardiovascular examination is listed. In FIG. 5, “XA” denoting an X-ray contrast examination, “ECG” denoting an electrocardiogram examination, “polygraph” denoting a hemodynamic examination, and “IVUS” denoting an IVUS examination are shown. The content displayed on each of the columns is displayed at a position determined along an identical time axis.

In the time column, a time of execution of each of the events (procedure time) is displayed in the chronological order. In the event column, Start and End of the cardiovascular examination are displayed, and additionally, the type of each of the events (procedure item) executed during the examination is displayed in the chronological order. A text “ev-1”, etc. displayed in the event column indicates a procedure item for each event. Moreover, in the event column, procedure time marks 101-104 are displayed, which indicate the positions of the procedure times on the chronological order. Each of the procedure time marks 101-104 is a V-shaped image.

In the observation range, a range on the abovementioned time axis based on the observation period set for each event is displayed.

In the examination time column, the examination time for each examination is displayed. Regarding “XA” in FIG. 5, three examination times 121-123 are displayed. The examination time 121 represents an X-ray contrast examination started before an procedure item “ev-a” and ended after a procedure item “ev-b.” Moreover, the examination time 122 represents a measurement based on an image captured during the examination time 121. Moreover, the examination time 123 represents an X-ray contrast examination conducted after the measurement.

An examination time 131 for “ECG,” an examination time 141 for “polygraph,” and examination times 151 and 152 for “IVUS” represent in a similar fashion.

An example of a method of creating the chronological display screen 100 will be described. The controller 11 first creates the time column and the event column, based on the association between the procedure item and procedure time recorded in the procedure log. On the chronological display screen 100, a time axis extending in a specified direction (rightward in FIG. 5) is set. A display position of the procedure time in the time column and a display position of the procedure item in the event column are determined according to this time axis.

This time axis does not need to have equally spaced units of time. For example, if many events are executed within a certain period during a cardiovascular examination, it is desirable to increase the distance of the unit time in a range corresponding to this period and display all procedure items. Thus, on the chronological display screen 100, it is more important to express which examination has been conducted at which timing in an easy-to-understand manner than the passage of time.

The observation range displayed in the observation range column is calculated based on the procedure time of each event recorded in the procedure log and the observation period set in advance. The calculated observation range is displayed at a position according to the abovementioned time axis.

The examination time displayed in the examination time column is determined based on the examination time recorded in the incidental information of the examination data. For example, the examination time of the first data in the examination data can be used as the start time of the examination time, and the examination time of the last data can be used as the end time of the examination time. The determined examination time is displayed at a position according to the abovementioned time axis. This concludes the description of the chronological display screen 100.

When the chronological display screen 100 is displayed, the operator operates the operation part 14 to designate a desired event (S24). An event is designated by, for example, clicking a desired one of the procedure time marks 101-104 with a mouse. Moreover, an event may be selected by clicking a desired one of the observation ranges 111-114.

The extracting part 16 specifies the observation period and procedure time that correspond to the designated event, and extracts partial data for observation from each examination data based on the specified observation period and procedure time (S25).

The synchronizer 17 synchronizes the partial data extracted from the respective examination data (S26). Subsequently, the controller 11 controls the display 13 so as to display the synchronized partial data synchronized (S27). The operator observes the displayed partial data and, for example, creates a report (S28). This concludes the usage pattern in observation of examination data.

### [Display Pattern of Data]

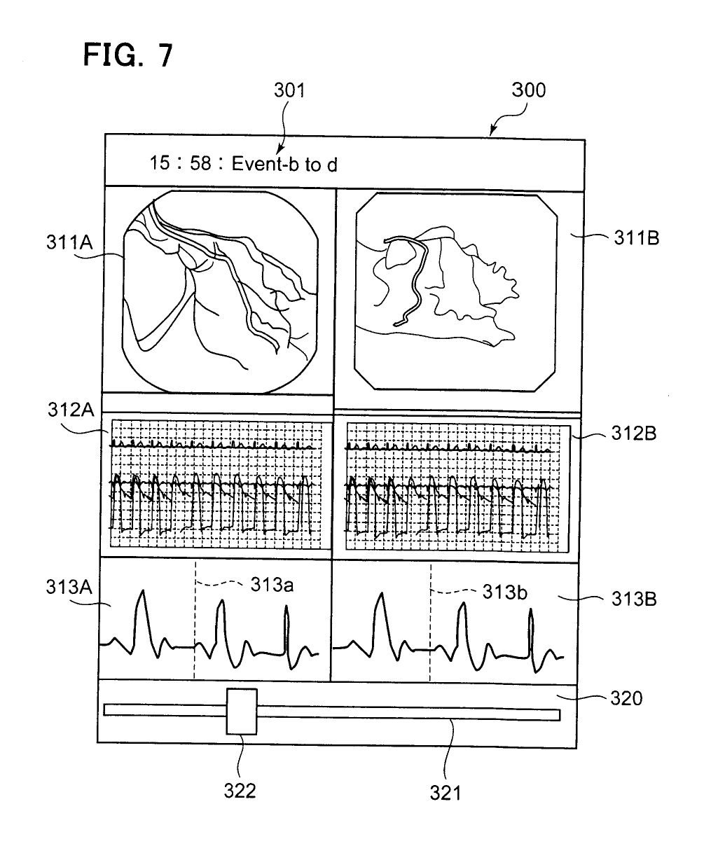

Display patterns of data displayed in Step 27 will be described. Here, two display patterns will be described with reference to FIG. 6 and FIG. 7.

### (First Display Pattern)

FIG. 6 shows an example of the display pattern of partial data in a case where an event of a procedure item “ev-c” of FIG. 5 is designated. As shown in FIG. 5, at the time of execution of this event, XA, ECG, polygraph and IVUS are examined, respectively.

A data replay screen 200 shown in FIG. 6 has an event presentation part 201 that presents a designated event. Consequently, the operator can recognize the designated event.

Below the event presentation part 201, data presentation parts 211-214 configured to present partial data are provided. In the data presentation part 211, part of a moving image captured by the X-ray diagnostic device 1A is presented. In the data presentation part 212, part of an electrocardiogram acquired by the electrocardiograph 1B is presented. In the data presentation part 213, part of a moving image captured by the IVUS device 1D is presented. In the data presentation part 214, part of a polygraph acquired by the hemodynamic examination system 1C is presented. Each of the presented partial data is a portion corresponding to the observation range 113 in the examination data.

Below the data presentation parts 211-214, a presentation operation part 220 is provided. The presentation operation part 220 is used to operate data presented on the data presentation parts 211-214.

The presentation operation part 220 has an observation range image 221 that indicates an observation range of a designated event. The observation range image 221 indicates the observation range 113 of FIG. 5, and is an image with the horizontal direction as the longer direction.

A procedure time mark 222 is provided on the left end of the observation range image 221. The procedure time mark 222 indicates the position of the procedure time of the event in the observation range shown by the observation range image 221. In a case where another event is designated, a procedure time mark is presented at a position according to that event. For example, in a case where the event of the procedure item “ev-b” is designated, the procedure time mark is presented at a position near the center of the observation range image.

In addition, a slider 223 is disposed on the observation range image 221. The slider 223 is moved by, for example, dragging with a mouse in the horizontal direction (i.e., longer direction of the observation range image 221).

The controller 11 controls the data presentation parts 211-214 so as to present data at the time corresponding to the position of the slider 223 in the observation range image 221, respectively. Specifically, by moving the slider 223 to a desired position, the operator can observe four data at the time according to the position. Because the four data are mutually synchronized by the synchronizer 17, it is possible to easily manage such a synchronized display.

An image captured by the X-ray diagnostic device 1A or the IVUS device 1D can be presented by selecting an image corresponding to the position of the slider 223, but for an electrocardiogram and a polygraph, a waveform (graph) in a specified period that includes the time is presented.

Moreover, it is also possible to continuously present data in the period of the observation range 113. In this case, moving images in the period are presented on the data presentation parts 211 and 213, respectively, and temporal changes of the waveform within the period are presented on the data presentation parts 212 and 214, respectively. In this case, the four data are also displayed synchronously. Specifically, the data presented in the respective data presentation parts 211-214 at each time point are data acquired at the same time.

### (Second Display Pattern)

When one event is designated, the abovementioned data replay screen 200 synchronously displays examination data corresponding to an event. The second display pattern described below is a screen that is displayed when a plurality of events are designated. This screen is convenient in the case of comparing examination data of different times, such as in the case of comparing the blood flow before and after catheter treatment. FIG. 7 indicates a display screen when a plurality of events are designated.

A data comparison screen 300 shown in FIG. 7 is displayed when two events are designated. Here, a case in which two events of the procedure items “ev-b” and “ev-d” in FIG. 5 are designated will be described.

The data comparison screen 300 is provided with an event presentation part 301 that presents two events. In the event presentation part 301, the procedure time of one of the events (here, an event of procedure item “ev-b” here) is presented. The procedure times of both events may be presented. Moreover, in the event presentation part 301, the text “Event-b to d” which indicates the two events is presented. With such presentation, an operator can recognize the events for comparison.

Below the event presentation part 301, data presentation parts 311A-313A presenting partial data of the event of the procedure item “ev-b” and data presentation parts 311B-313B presenting partial data of the event of the procedure item “ev-d” are provided.

The data presentation parts 311A and 311B are positioned side by side with each other in the horizontal direction. In the data presentation parts 311A and 311B, parts of a moving image captured by the X-ray diagnostic device 1A are presented, respectively. The data presentation parts 312A and 312B are positioned side by side with each other in the horizontal direction. In the data presentation parts 312A and 312B, parts of a polygraph acquired by the hemodynamic examination system 1C are presented, respectively. The data presentation parts 313A and 313B are positioned side by side with each other in the horizontal direction. In the data presentation parts 313A and 313B, parts of an electrocardiogram acquired by the electrocardiograph 1B are presented, respectively.

In the electrocardiograms presented in the data presentation parts 313A and 313B, time phases are synchronized with each other. Moreover, the data presented in the data presentation parts 311A and 312A are synchronized with the electrocardiogram of the data presentation part 313A, respectively. Similarly, the data presented in the data presentation parts 311B and 312B are synchronized with the electrocardiogram of the data presentation part 313B, respectively. Therefore, all of the data presented in the data presentation parts 311A-313A and 311B-313B are synchronized. These data are synchronized by the synchronizer 17. The controller 11 presents these data on the data presentation parts 311A-313A and 311B-313B in synchronization with each other.

On the electrocardiograms presented in the data presentation parts 313A and 313B, time-phase indication images 313a and 313b that indicate the time phase of data presented on the data presentation parts 311A, 312A, 311B and 312B are displayed, respectively. Specifically, in the data presentation part 311A, an image at a time phase that the time-phase indication image 313a indicates is presented. Moreover, in the data presentation part 311B, an image at a time phase that the time-phase indication image 313b indicates is presented. Similarly, in the data presentation part 312A, a polygraph including the time phase that the time-phase indication image 313a indicates is presented, and in the data presentation part 312B, a polygraph including the time phase that the time-phase indication image 313b indicates is presented. Consequently, the operator can easily grasp what time phase is presented.

A presentation operation part 320 is disposed below the data presentation parts 311A-313A and 311B-313B. The presentation operation part 320 is provided with an observation range image 321 and a slider 322, as in the data replay screen 200.

When the slider 322 is moved, the time-phase indication images 313a and 313b presented in the data presentation parts 313A and 313B move along the time axes of the electrocardiograms (specifically, the time phase is changed). At this moment, the controller 11 controls the data presentation parts 311A, 312A, 311B and 312B so as to present the data at a time phase that the time-phase indication images 313a and 313b indicate, respectively. Consequently, the operator can easily designate data at a desired time phase and observe it.

Moreover, it is possible to continuously present data on the data comparison screen 300. In this case, moving images are presented in the data presentation parts 311A and 311B, respectively, and temporal changes of the polygraph are presented on the data presentation parts 312A and 312B, respectively. At this moment, the time-phase indication images 313a and 313b also move on the electrocardiograms in the direction of the time axis. With such display patterns, the operator can easily compare temporal changes of the data and grasp the time phase at which the changes are observed.

### [Actions and Advantageous Effects]

The actions and advantageous effects of the examination system according to this embodiment will be described. As previously described, the examination-data processing apparatus according to the present invention can be configured by excluding at least the examination apparatus 1 from the examination system. Therefore, the processing device can produce similar actions and advantageous effects as in the examination system.

This examination system comprises the examination apparatus 1 and the workstation 10. The examination apparatus 1 acquires a plurality of examination data from an examination conducted on a patient, and further acquires an examination time of each of the examination data. Furthermore, the workstation 10 generates a procedure log that associates a procedure item executed on a patient with the procedure time. Moreover, the workstation 10 extracts partial data within a range that corresponds to one procedure item from each of the examination data, based on the examination time and the procedure log, and displays the extracted partial data on the display 13 by synchronizing them. This is the action as the “controller” according to the present invention. The display 13 functions as an example of the “display” according to the present invention.

Moreover, the examination system has the time server 2 (timer 22) that times the reference time. The workstation 10 receives the reference time from the time server 2, and associates the procedure time on the reference time with the procedure item to create the procedure log. Furthermore, the time-difference calculator 23 and the time-difference regulator 32 convert the examination time to a time corresponding to the reference time. This is the action as the “converter” according to the present invention. Furthermore, the workstation 10 acts so as to extract partial data based on related information and the examination time that corresponds to the reference time.

The converter can be installed at any location within the examination system. In this embodiment, the converter is composed of the time-difference calculator 23 and the time-difference regulator 32, but it is possible to configure so that one device performs both the processes.

Further, the examination apparatus 1 can acquire moving image data including a plurality of still image data. The moving image data includes X-ray moving image data acquired from the X-ray diagnostic device 1A, and intravascular ultrasonic moving image data acquired from the IVUS device 1D. The workstation 10 acts so as to extract, as the abovementioned partial data, still image data within a range that corresponds to one procedure item from each moving image data, and further display the moving image data based on the extracted still image data on the display 13. This process is executed based on a time when each still image data has been captured and the procedure log.

Furthermore, the examination apparatus 1 can acquire graph data indicating temporal changes in the condition of a patient. The graph data includes electrocardiograph data acquired from the electrocardiograph 1B and polygraph data acquired from the hemodynamic examination system K1C. Such graph data is created by acquiring a patient's state at specified time intervals. The workstation 10 actions so as to extract, as the abovementioned partial data, data (partial graph data) within a range corresponding to one procedure item from graph data, and further display a graph based on the extracted partial graph data on the display 13. This process is executed based on a time when the data for creating the graph data has been acquired (data acquisition time) and the procedure log.

Furthermore, the examination system has the operation part 14. The operation part 14 is used as an example of the “operation part” according to the present invention. The workstation 10 controls the display 13 so as to display the chronological display screen 100 based on the examination time and the procedure log. The chronological display screen 100 is a screen presenting procedure items in the chronological order.

The operator operates the operation part 14 to designate a procedure item on the chronological display screen 100. The workstation 10 extracts partial data in a range corresponding to the designated procedure item, and displays the partial data by synchronizing them.

Furthermore, if two or more procedure items shown in the chronological display screen 100 are designated, the workstation 10 controls the display 13 so as to display the data comparison screen 300 displaying partial data in a range corresponding to the procedure items for each examination.

According to the examination system acting in this manner, it is possible to display while automatically synchronizing examination data acquired from a plurality of examinations. Therefore, it is possible to easily perform synchronous replay of a plurality of examination data.

Furthermore, the operator can easily select an event or examination to observe on the chronological display screen 100. Furthermore, the operator can observe examination data acquired at the time of execution of a certain event on the data replay screen 200. Furthermore, the operator can easily perform a comparative observation of examination data acquired at different times.

### [Modification]

The above-described configurations are merely examples for implementing the present invention. In other words, when implementing the invention, it is possible to modify without departing from the scope of the invention. An example of the modification will be described below.

### [Modification 1]

It is possible to configure so that, in the chronological display screen 100 shown in FIG. 5, it is possible to designate a desired examination presented in the examination time column and selectively display only examination data of the designated examination.

For example, by designating an event of the procedure item “ev-c” and further clicking “XA” and “polygraph” in the examination column, it is possible to display only an X-ray image and polygraph corresponding to the event. The method for designating an examination is not limited to the above. For example, it is possible to configure to designate the examination time 121, etc., or use a pull-down menu, etc., that presents so that a plurality of examinations can be designated.

As described above, the chronological display screen 100 presents the content of an examination by each device of the examination apparatus 1, together with a procedure item. After designation of the content of the examination with the operation part 14, the workstation 10 acts to display partial data of only the designated content of the examination. Consequently, the operator can selectively display a desired examination by easy operation.

Here, the “content of an examination” may be any information on an examination presented on the chronological display screen 100. To be specific, information indicating the types of an examination and an examination device (“XA,” “ECG” and the like shown in FIG. 5), and the examination time of each examination (the examination time 121 and the like shown in FIG. 5) are designated by the operator as the “contents of an examination.”

### [Modification 2]

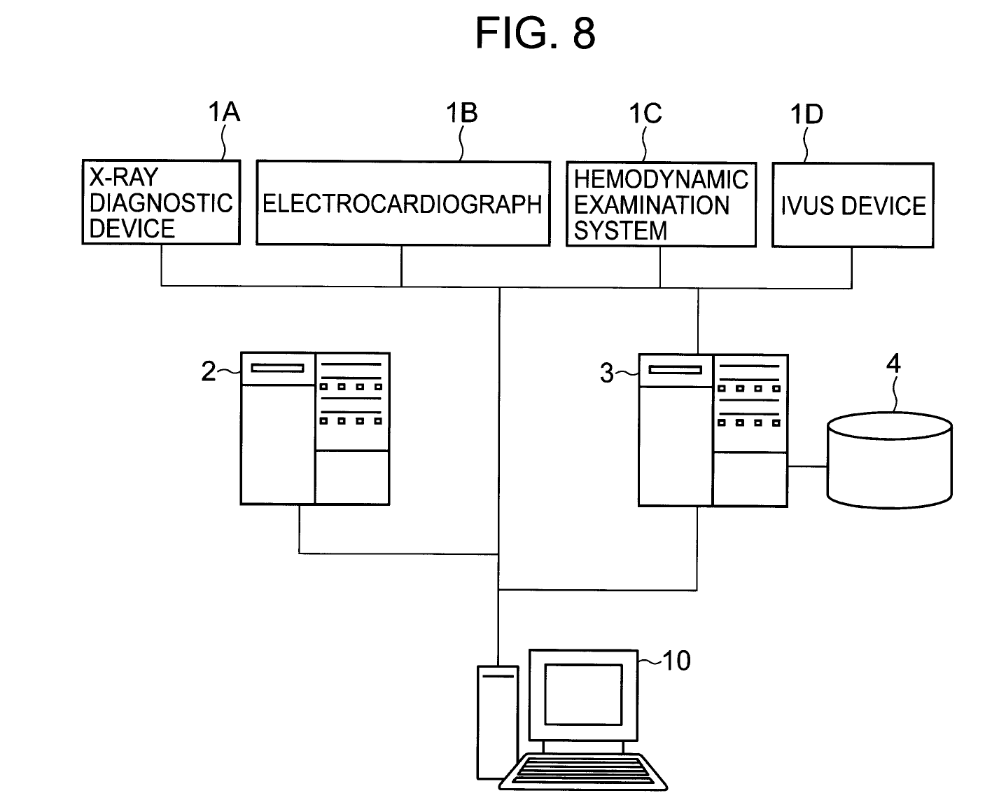

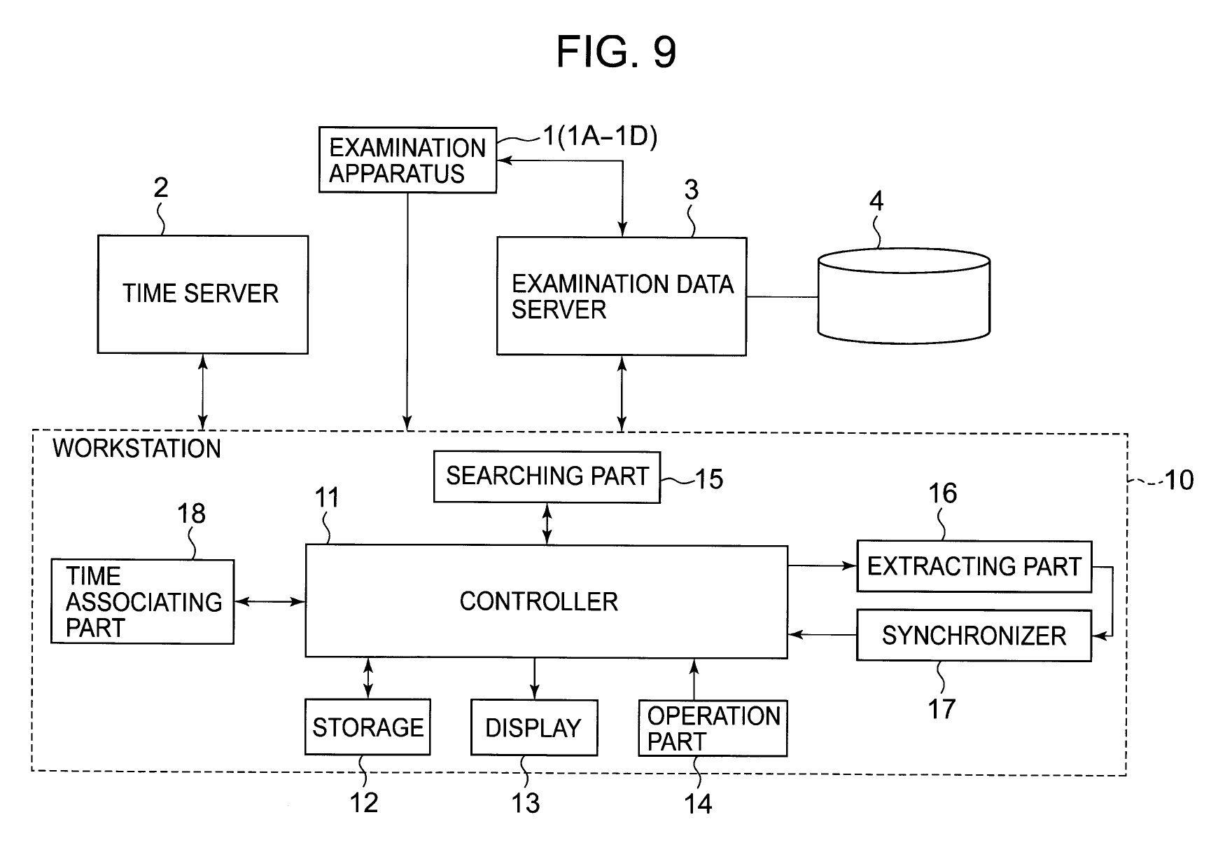

In this modification, an examination system having a different system configuration from the above-described embodiment will be described. FIG. 8 and FIG. 9 show the configuration of the examination system according to this modification. Components of FIGS. 8 and 9 similar to those of FIGS. 1 and 2 are denoted by the same reference symbols.

As in the above embodiment, the examination system of this modification comprises the examination apparatus 1 (1A-1D), the timeserver 2, the examination data server 3, the examination database 4 and the workstation 10.

In this modification, each device of the examination apparatus 1 does not need to be connected with the timeserver 2 by a communication network. Further, in this modification, each device of the examination apparatus 1 is connected with the workstation 10 so as to be communicable.

Furthermore, the timeserver 2 in this modification does not need to include the time-difference calculator 23. Moreover, the examination data server 3 in this modification does not need to include the time-difference regulator 32.

The workstation 10 in this modification includes a time associating part 18. The workstation 10 receives a reference time from the timeserver 2. Further, the examination time (and the transmission time) acquired from each device of the examination apparatus 1 is inputted into the workstation 10. The time associating part 18 associates the reference time at the input timing with the examination time inputted from the examination apparatus 1. The time associating part 18 functions as an example of the “time associating part” according to the present invention.

Thus, with the workstation 10, it is possible to integrally manage the procedure time of the procedure log and the examination time of the examination apparatus 1 by using the reference time provided by the timeserver 2. Consequently, the extracting part 16 can extract partial data of the examination data with reference to the reference time. Further, the synchronizer 17 can synchronize the partial data with reference to the reference time.

An example of the usage pattern of the examination system in accordance with the modification will be described. Below, the usage pattern in acquisition of examination data, etc., and the usage pattern in observation of examination data will be described separately.

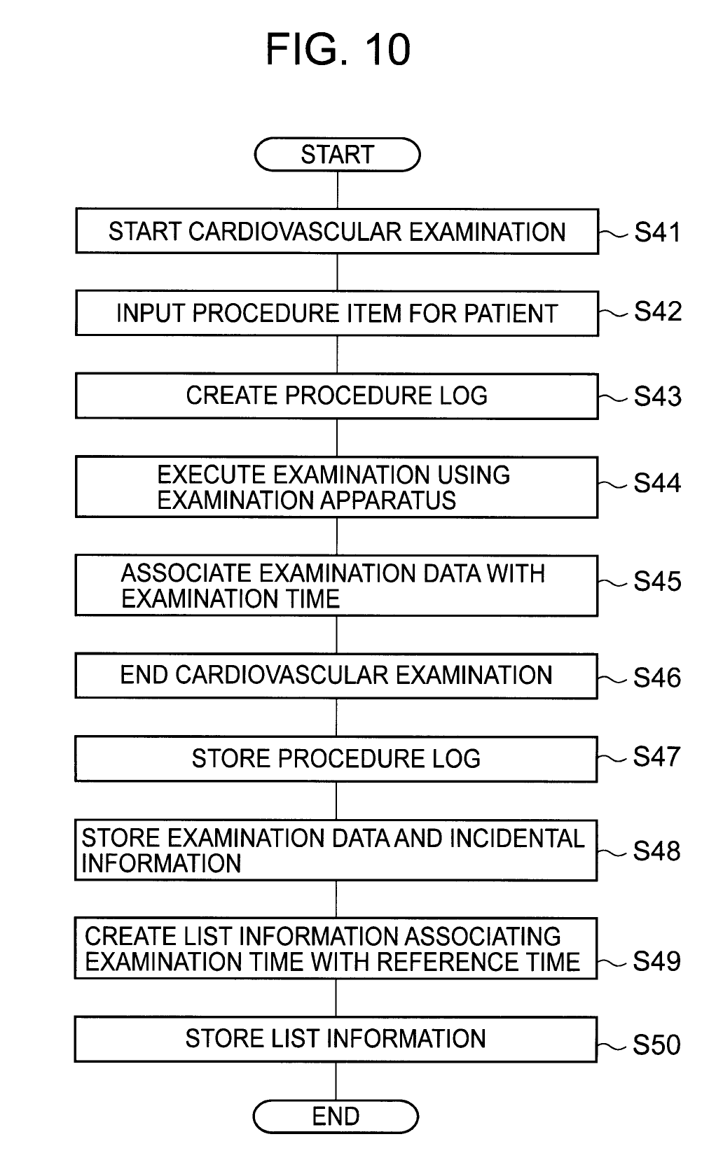

An example of the usage pattern in acquisition of examination data, etc., will be described with reference to a flowchart shown in FIG. 10.

A cardiovascular examination is started (S41). When a procedure is executed on a patient, a person like a nurse inputs the procedure items into the workstation 10 (S42). The controller 11 associates the inputted procedure items with the reference time provided by the timeserver 2 to create the procedure log (S43).

Further, a person like a doctor conducts an examination using the examination apparatus 1 on the patient (S44). The examination apparatus 1 associates the examination time with acquired examination data (S45). The examination time is recorded as, for example, incidental information of the examination data. Here, creation of the procedure log and the examination by the examination apparatus 1 are executed at arbitrary timing during the course of the cardiovascular examination, and executed in any order and at any number of times.

When the cardiovascular examination is ended (S46), the controller 11 of the workstation 10 stores the created procedure log into the storage 12, together with the cardiovascular examination ID and the patient ID (S47).

Furthermore, each device of the examination apparatus 1 sends the examination data and the incidental information to the examination data server 3. The examination data server 3 stores the examination data and the incidental information received from each device of the examination apparatus 1 into the examination database 4 (S48).

Furthermore, each device of the examination apparatus 1 sends the examination ID, the examination time and the transmission time to the workstation 10. The time associating part 18 associates the reference time with each of the examination times (S49). This process is executed by creating list information associating the examination time with the reference time, for example.

The controller 11 stores the abovementioned list information on the examination time into the storage 12 (S50). The respective list information are associated with, for example, the corresponding examination IDs, so that they can be searched based on the examination IDs. This concludes the description of the usage pattern in acquisition of examination data, etc.

Next, an example of the usage pattern in observation of examination data will be described. Because this usage pattern is mostly the same as that of the abovementioned embodiment, this usage pattern will be described with reference to a flowchart shown in FIG. 4.

First, the operator inputs a patient ID and a cardiovascular examination ID into the workstation 10 (S21). The searching part 15 acquires examination data and incidental information that correspond to the inputted ID, from the examination data server 3 (S22).

The controller 11 retrieves a procedure log and incidental information that are associated with the ID inputted in step 21, from the storage 12. Furthermore, as in the abovementioned embodiment, the controller 11 controls to display the chronological display screen 100 based on the retrieved data (S23).

The operator designates a desired event (S24). The extracting part 16 specifies an observation period and a procedure time that correspond to the designated event. At this moment, as stated above, the respective times are integrally managed with reference to the reference time, so that the specified procedure time is shown by the reference time. Furthermore, the extracting part 16 extracts partial data to become an observation target from each of the examination data, based on the specified observation period and procedure time (S25).

The synchronizer 17 synchronizes the partial data extracted from the respective examination data (S26). The controller 11 controls the display 13 to display displays the synchronized partial data (S27). The operator observes the displayed partial data and, for example, creates a report (S28). This concludes the description of the usage pattern in observation of examination data.

Since this examination system functions so as to automatically synchronize and display examination data acquired from a plurality of examinations, it is possible to easily perform synchronous replay of a plurality of examination data.

### [Modification 3]

In an examination or surgery, there is a case of creating a procedure log in handwriting and thereafter inputting the procedure log into a computer. Also in this case, it is possible to perform synchronous replay of a plurality of examination data with a configuration similar to those of, for example, the abovementioned embodiment and the Modification 2.

A specific example will be described below with reference to the configuration of the abovementioned embodiment (FIG. 1 and FIG. 2).

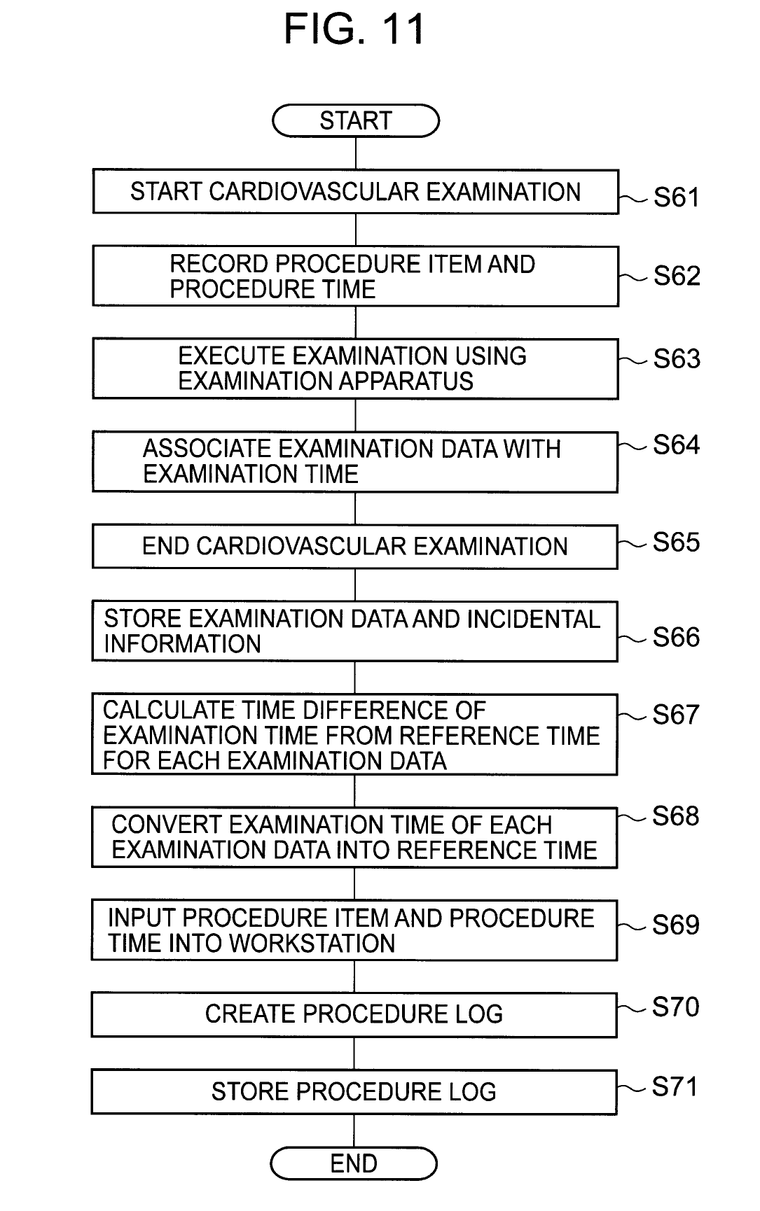

First, referring to FIG. 11, an example of a usage pattern in acquisition of examination data, etc. will be described. A cardiovascular examination is started (S61). When a procedure is executed on a patient, a person like a nurse records the procedure item and procedure time onto a specified sheet or the like in handwriting (S62). The procedure time is recorded with reference to, for example, a clock installed in an examination room.

Further, a person like a doctor executes an examination using the examination apparatus 1 (S63). The examination apparatus 1 associates the examination time with acquired examination data (S64). The examination time is recorded as, for example, incidental information of the examination data. Record of a procedure item and an examination using the examination apparatus 1 are performed at arbitrary timing, respectively.

When the cardiovascular examination is ended (S65), each device of the examination apparatus 1 sends the examination data and the incidental information to the examination data server 3. The examination data server 3 stores the examination data and the incidental information into the examination database 4 (S66).

Further, each device of the examination apparatus 1 sends the examination ID, the examination time and the transmission time to the timeserver 2. The time-difference calculator 23 calculates the time difference of each of the examination times from the reference time (S67). The controller 21 sends the time difference of each of the examination times, together with the examination ID, etc. to the examination data server 3. The time-difference regulator 32 converts the examination time of each of the examination data into the reference time (S68). The result of this conversion is recorded to the incidental information, and stored into the examination database 4.

The operator inputs the procedure item and procedure time recorded in step 62 into the workstation 10 (S69). The controller 11 associates the inputted procedure item and procedure time to create a procedure log (S70). The controller 11 stores the created procedure log together with the cardiovascular ID and the patient ID into the storage 12 (S71). This concludes the description of the usage pattern in acquiring examination data, etc.

Next, an example of a usage pattern in observation of examination data will be explained with reference to FIG. 4 of the aforementioned embodiment. After the operator inputs the patient ID and cardiovascular examination ID into the workstation 10 (S21), the searching part 15 acquires the examination data and incidental information from the examination data server 3 (S22). The acquired examination data, etc., are stored in the storage 12. The controller 11 retrieves the procedure log and incidental information associated with the ID inputted in step 21 from the storage 12, creates the chronological display screen 100 (see FIG. 5), and controls the display 13 so as to display the screen 100 (S23).

In a stage prior to creation of the chronological display screen 100, the procedure time recorded on the procedure log is not converted into the reference time yet. Meanwhile, the examination time recorded on the incidental information is already converted into the reference time. Therefore, when creating the chronological display screen 100, it is necessary to match the time axes of the two times. Here, a case of converting the procedure time into the reference time will be explained. However, the opposite case can likewise be performed.

To match the time axes of the two times, it is necessary to (almost) simultaneously recognize an occurrence time of a certain event. For example, for the examination time and the reference time, the examination apparatus 1 as a sender and the timeserver 2 as a receiver recognize an event of data transmission, respectively, whereby the time axes are matched. However, in this modification, the procedure log is recorded in handwriting, and therefore, it is impossible to match the time. Accordingly, in this modification, it is difficult to precisely match the time axis of the procedure time with the time axis of another time. Consequently, in this modification, the chronological display screen 100 is created by considering the recorded procedure time as a time in the time axis of the reference time.

When the chronological display screen 100 is displayed, the operator designates a desired event (S24). The extracting part 16 extracts partial data corresponding to the designated event from each examination data (S25). The synchronizer 17 synchronizes the partial data extracted from the respective examination data (S26). The controller 11 controls the display 13 to display the synchronized partial data (S27). The operator observes the displayed partial data to create a report, for example (S28). This concludes the description of the usage pattern in monitoring examination data.

With this examination system, even when later inputting the procedure log recorded in handwriting, it is possible to automatically synchronize and display the examination data from a plurality of examinations.

### [Another Modification]

In the aforementioned embodiments, the examination system applied to a cardiovascular examination is described. However, it is possible to apply this invention to any examination or surgery that requires a plurality of examination data, without limiting to the above. In this case, an examination device needs to be installed in consideration of the application target of the examination system.

The examination system according to the abovementioned embodiment comprises the examination apparatus 1, the timeserver 2, the examination data server 3, the examination database 4 and the workstation 10, but the configuration of the examination system is not limited thereto.

For example, a function of providing a reference time or a function of calculating a time difference may be provided in any device other than the timeserver 2. In this case, it is possible to adopt a system configuration without the timeserver 2. Furthermore, a function of regulating a time difference may also be provided in any device other than the examination server 3.

Instead of providing the reference time via the timeserver 2, etc., it is possible to use a time measured by any of the plurality of examination devices as the reference time. For example, in the configuration shown in FIG. 1, in the case of using a time measured by the X-ray diagnostic device IA as the reference time, the workstation 10 converts the examination time provided from the other examination devices 1B, 1C and 1D into the reference time provided by the X-ray diagnostic device 1A, thereby being capable of matching the time axes of the times provided by the examination devices 1A-1D. In this case, the workstation 10 needs to grasp the time difference between the time measured by the examination device 1A and the times measured by the respective examination devices 1B-1D. The time difference can be acquired by, for example, simultaneously acquire the times from the respective examination devices 1A-1D and calculating the difference.

The workstation 10 may be any computer used for observation of examination data, other than a computer for diagnostic reading or report creation. Furthermore, the computer may be a so-called stand-alone computer, which is not connected to a communication network. In this case, it is possible to record information such as examination data in a recording medium such as a CD-R and a DVD-R. The computer can input by reading the information recorded in the recording medium with a drive device.

In the abovementioned embodiment, a plurality of examination data (moving images, graphs, etc.) acquired in the chronological order, respectively, are synchronously displayed. At this moment, it is possible to freeze at least one of the examination data. For example, it is possible to freeze a moving image at desired timing and observe a still image of a heart while synchronously displaying the moving image of the heart and an electrocardiogram. Furthermore, when the freezing of the moving image is ended, it is possible to synchronously display the moving image and the electrocardiogram again. A request to start or end the freezing can be made by operating the operation part 14. Further, it is also possible to configure so as to automatically start the freezing at specified timing (e.g., a time phase of an R-wave in an electrocardiographic).

The embodiments and modifications described above can also be applied to the examination-data processing apparatus according to the present invention. Further, the examination data described in the above embodiments and modifications is visual information such as images and graphs. However, the examination data of this invention is not limited to the above. For example, the examination data may be audio information such as heart sounds.

### [Examination-Data Processing Apparatus]

The examination-data processing apparatus according to the present invention has been explained in detail in the abovementioned embodiments. Hereinafter, a brief description of the examination-data processing apparatus will be provided.

The examination-data processing apparatus according to the present invention has a storage configured to store examination data acquired by an examination apparatus and an examination time in association with each other, and store a procedure item executed on a patient relating to the examination by the examination apparatus and a procedure time in association with each other. Furthermore, the examination-data processing apparatus comprises a display and a controller that are described in the above embodiments. The storage includes any device configured to store the examination data or the like, such as a PACS and an electronic medical chart system. In the above embodiments, the examination data server 3 and the examination database 4 function as the storage. Further, a storage device (such as a hard disk drive) built in the examination-data processing apparatus may be used as the storage.

Furthermore, the examination-data processing apparatus according to the present invention may have a converter and a controller as described in the above embodiments. The functions of the respective devices and the operation of the examination-data processing apparatus are similar to those of the examination system according to the above embodiments.

The examination-data processing apparatus may be configured by a single device, or may be configured including two or more devices. As the former case, it is possible to configure the examination-data processing apparatus by the workstation 10 of the above embodiment alone. As the latter case, it is possible to configure the examination-data processing apparatus by at least one of the timeserver 2, examination data server 3 and examination database 4, and the workstation 10. In a case where the examination-data processing apparatus is configured by two or more devices, these devices and a communication network connecting the apparatuses functions as the examination-data processing apparatus.

What is claimed is:

1. An examination-data processing apparatus comprising:
a storage configured to store by associating each of a plurality of examination data of a patient acquired by an examination apparatus with an examination time indicating time when the examination data has been acquired, and store by associating procedure items executed on the patient in relation to the examination by the examination apparatus with procedure times thereof;
a display; and
a controller configured to extract partial data in a time range corresponding to a specific procedure item from each of the plurality of examination data based on the examination time and the procedure times, and control the display to synchronously display the plurality of extracted partial data.

2. The examination-data processing apparatus according to claim 1, further comprising an operation part,
wherein the controller controls the display to display a chronological display screen presenting the procedure items in a chronological order based on the examination time and the procedure times, when the presented procedure items are designated by the operation part, extracts partial data within a time range corresponding to the designated procedure items, and controls the display to synchronously display the extracted partial data.

3. The examination-data processing apparatus according to claim 2, wherein:
the chronological display screen presents information indicating an examination content for acquiring each of the plurality of examination data together with the procedure items; and
when the presented information is designated by the operation part, the controller controls to display the partial data only for an examination content indicated by the designated information.

4. The examination-data processing apparatus according to claim 2, wherein when two or more procedure items are designated by the operation part, the controller controls to display partial data in a time range corresponding to the two or more procedure item side by side for each examination.

5. The examination-data processing apparatus according to claim 1, wherein the controller specifies a time range corresponding to the specific procedure item based on the procedure time associated with the specific procedure item and a previously set observation period.

6. The examination-data processing apparatus according to claim 1, wherein:
the storage stores by associating the procedure time corresponding to a specified reference time with the procedure item; and
the controller includes a converter configured to convert the examination time into a time corresponding to the reference time, and extracts the partial data based on the procedure time and the examination time that correspond to the reference time, respectively.

7. The examination-data processing apparatus according to claim 1, wherein:
at least one of the plurality of examination data is moving image data including a plurality of still image data; and
the controller extracts still image data in a time range corresponding to the specific procedure item from the plurality of still image data as the partial data, and controls the display to display a moving image based on the extracted still image data.

8. The examination-data processing apparatus according to claim 7, wherein:
the storage stores a capture time of each of the plurality of still image data as the examination time; and
the controller extracts still image data in a time range corresponding to the specific procedure item based on the capture time and the procedure time, and controls to display a moving image based on the extracted still image data.

9. The examination-data processing apparatus according to claim 7, wherein the moving image data is X-ray moving image data or intravascular ultrasonic moving image data.

10. The examination-data processing apparatus according to claim 1, wherein:
at least one of the plurality of examination data is graph data indicating a temporal change in state of the patient; and
the controller extracts partial graph data in a time range corresponding to the specific procedure item from the graph data as the partial data, and controls the display to display a graph based on the extracted partial graph data.

11. The examination-data processing apparatus according to claim 10, wherein:
the graph data is formed by acquiring the state of the patient at specified time intervals;
the storage stores a data acquisition time at every specified time interval as the examination time; and
the controller extracts the partial graph data based on the data acquisition time and the procedure time, and controls to display a graph based on the extracted partial graph data.

12. The examination-data processing apparatus according to claim 10, wherein the graph data is electrocardiograph data or polygraph data.

13. An examination system comprising:
an examination apparatus configured to acquire a plurality of examination data from examinations on a patient, and acquire an examination time indicating time when each of the plurality of examination data is acquired;
a storage configured to store by associating procedure items executed on the patient in relation to the examination by the examination apparatus with procedure times thereof;
a display; and
a controller configured to extract partial data in a time range corresponding to a specific procedure item from each of the plurality of examination data based on the examination time and the procedure time, and control the display to synchronously display a plurality of the extracted partial data.

14. The examination system according to claim 13, wherein:
a first server configured to time a reference time, a second server configured to manage a plurality of examination data acquired by the examination apparatus and an examination times, and a computer configured to receive input of a procedure items executed on the patient are comprised;
the first server and the second server are connected to the examination apparatus via communication network;
the first server, the second server and the computer are connected to each other via communication network;
the first server receives input of the examination time from the examination apparatus, and has a time-difference calculator configured to calculate a time difference of such examination time from the reference time;
the second server has a converter configured to convert the managed examination time into time corresponding to the reference time based on the calculated time-difference; and
the computer:
receives the reference time provided by the first server, and stores by associating the received procedure items with the provided reference time as the storage; and
receives the plurality of examination data and the converted examination time from the second server, extracts the partial data based on the examination time and the stored reference time, and controls the display to synchronously display the extracted partial data as the controller.

15. The examination system according to claim 13, wherein:
a first server configured to time a reference time, a second server configured to manage a plurality of examination data acquired by the examination apparatus and examination times, and a computer configured to receive input of procedure items executed on the patient are comprised;
the second server is connected to the examination apparatus via a communication network;
the computer is connected to the examination apparatus, the first server and the second server via a communication network, respectively; and
the computer:
includes a time associating part configured to receive input of the examination time from the examination apparatus and receive the reference time provided by the first server, and associates the inputted examination time with the reference time;
receives the reference time from the first server, and stores by associating the received procedure items with the reference time, as the storage; and
receives the plurality of examination data and the examination times from the second server, extracts the partial data based on the result of association by the time associating part, the provided examination time and the stored reference time, and controls the display to synchronously display the extracted partial data, as the controller.
